(19) United States
(12) Patent Application Publication
(10) Pub. No.: US 2002/0063406 A1
(43) Pub. Date: May 30, 2002

(54) Footboard of tricycle

(76) Inventor: Pin-Chieh Feng, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/753,618

(22) Filed: Jan. 4, 2001

(30) Foreign Application Priority Data
Nov. 29, 2000 (TW) 89220835

(51) Int. Cl. B62M 1/00; B62K 15/00; A63C 17/00

(52) U.S. Cl. 280/87.041

(57) ABSTRACT

A tricycle is formed of a front tube, a handlebar set fastened pivotally with the front tube, a front fork pivoted with the handlebar set, a front wheel pivoted to the front fork, two swiveling members fastened pivotally with the front tube, two footboards fastened with the swiveling members, and two rear wheels fastened pivotally to the underside of the rear end of the two footboards. The footboards are provided in the upper side with an inclined tread surface to minimize the likelihood that the ankle of a rider of the tricycle is injured.

### FIELD OF THE INVENTION

The present invention relates generally to a tricycle, and more particularly to a footboard of the tricycle.

### BACKGROUND OF THE INVENTION

As illustrated in FIG. 1, a prior art tricycle comprises two footboards on which a rider of the tricycle stands. The footboards are horizontally disposed and are therefore apt to inflict injuries on the ankles of the rider. The prior art tricycle comprises two rear wheels 93 and 94, which are respectively exerted on by the body weight of the rider. In other words, the body weight of the rider is distributed in the form of two equal forces Y₃ and Y₄. When the tricycle is making a left turn, the center of gravity of the rider's body weight is closer to the left rear wheel 93. Under such a circumstance as described above, the force Y₃ is greater than the force Y₄. As a result, the sum of the horizontal component forces Y₃₁ and Y₄₁ of the forces Y₃ and Y₄ is relatively greater. In light of the sum of the two centrifugal forces being relatively greater, the prior art tricycle in motion is relatively susceptible to overturn. In addition, the horizontal force of component Y₄ of the right rear wheel 94 is almost equal to the force of component Y₃₁, the right rear wheel 94 has a poorer capability of acceleration.

### SUMMARY OF THE INVENTION

The primary objective of the present invention is to provide a tricycle with two footboards which are free of the deficiencies of the prior art tricycle footboards described above.

The tricycle of the present invention comprises a front tube, a handlebar set pivoted with the front tube, a front fork pivoted to the handlebar set, a front wheel fastened pivotally with the front fork, two swiveling members pivoted to two sides of the front tube, two footboards mounted on the two swiveling members, and two rear wheels pivoted respectively to the undersides of the two footboards. The footboards are provided in the upper side with a tread surface of a predetermined inclination, with the direction of inclination being from the outer side of the tread surface toward the inner side of the tread surface.

### BRIEF DESCRIPTION OF THE DRAWINGS

FIG. 1 shows a schematic view of a prior art tricycle in action.

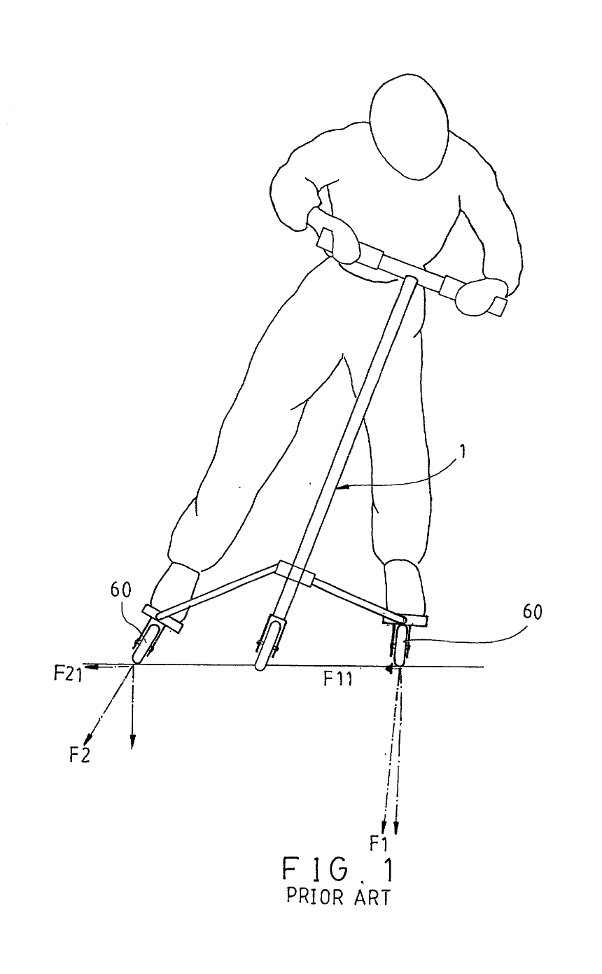

FIG. 2 shows a perspective view of a preferred embodiment of the present invention.

FIG. 3 shows a side view of the preferred embodiment of the present invention.

FIG. 4 shows a rear view of the preferred embodiment of the present invention.

FIG. 5 shows a top view of the preferred embodiment of the present invention.

FIG. 6 shows a sectional view taken along the direction indicated by a line 6-6 as shown in FIG. 3.

FIG. 7 shows a schematic view of a rear wheel of the present invention being exerted on by a rider's weight.

FIG. 8 shows a schematic view of the present invention in action.

### DETAILED DESCRIPTION OF THE INVENTION

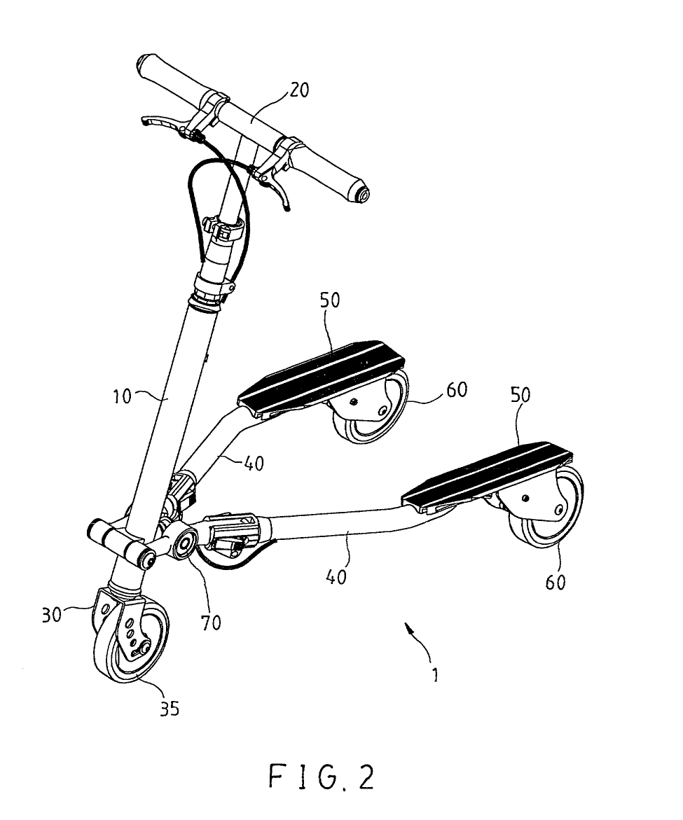

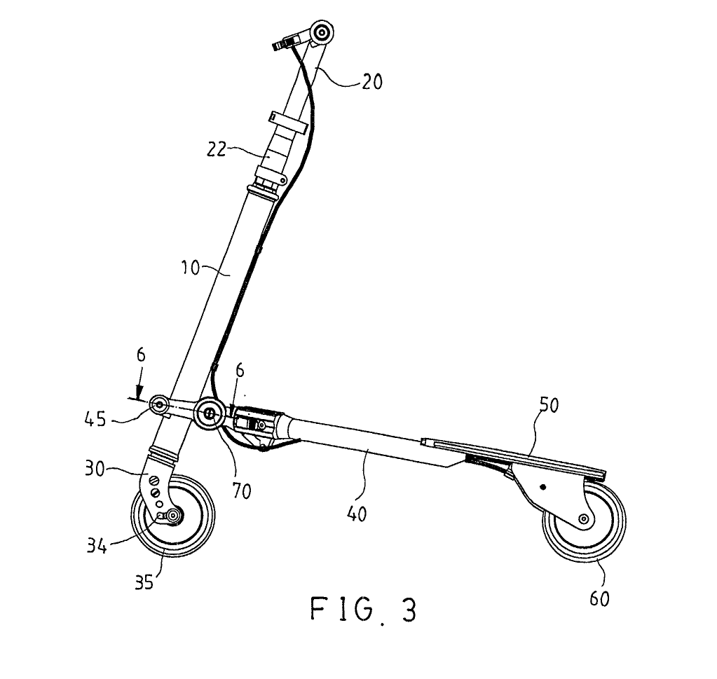

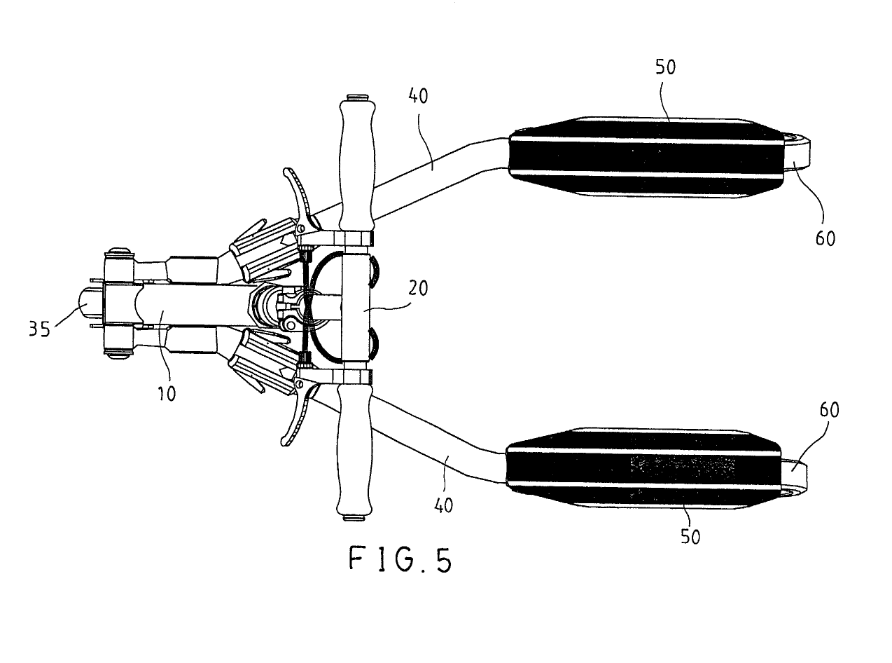

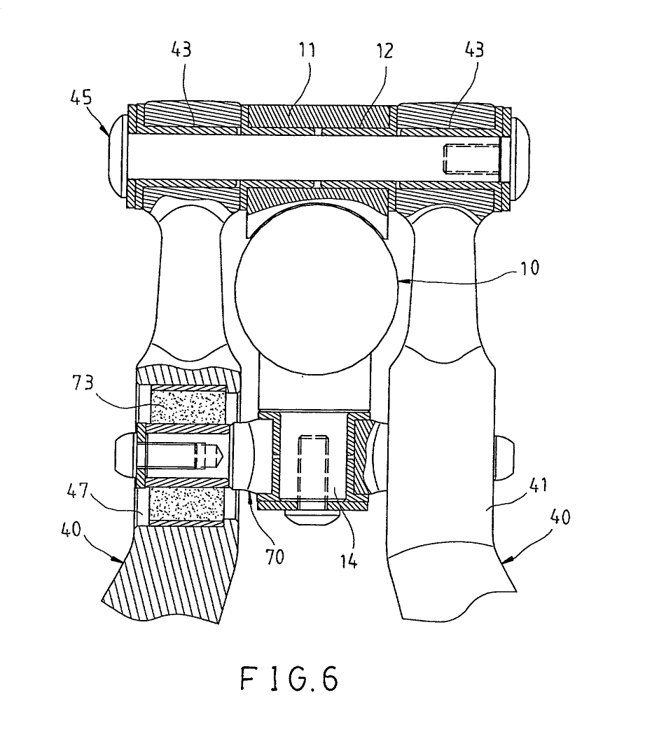

As shown in FIGS. 2-6, a tricycle 1 embodied in the present invention comprises the component parts which are described hereinafter.

A front tube 10 is provided at the front end with a pivoting seat 11 and a pivoting hole 12, and at the rear end with a pivoting pillar 14.

A handlebar set 20 has a tube pivoting portion 22, which is received in the front tube 10 such that both ends of the tube pivoting portion 22 are jutted out of the front tube 10. The handlebar set 20 further has two grip portions 24 extending from the tube pivoting portion 22.

A front fork 30 has two side wings 32 extending from the bottom end of the tube pivoting portion 22, with each of the two side wings 32 being provided with a wheel pivoting portion 34.

A front wheel 35 is pivoted with the wheel pivoting portion 34 of the front fork 30.

Two swiveling members 40 comprise a bottom tube 41 and a control hole 47. The bottom tube 41 is provided at the front end with a pivoting hole 43, which is pivoted with the pivoting hole 12 of the front tube 10 by a pivoting device 45. The control hole 47 is corresponding in location to the pivoting pillar 14 of the front tube 10.

Two footboards 50 are respectively fastened with the bottom tube 41 of the swiveling members 40 and are provided with a plate 51 having a tread surface 53 to accommodate the foot of a rider of the tricycle 1. The tread surface 53 inclines from the horizontal position an angle of Q, which ranges between 1 and 10 degrees.

Two rear wheels 60 are pivoted to the undersides of the two footboards 50 such that the direction of the pivot center of the rear wheels 60 is parallel to the tread surface 53, and that wheel center line forms an angle (R) with the plummet. The angle R is equal to the angle Q. The wheel center line is perpendicular to the tread surface 53.

A control member 70 is pivoted with the pivoting pillar 14 of the front tube 10 and is provided at both ends thereof with an elastomer 73 which is fastened with the control hole 47 of the swiveling members 40, so as to facilitate the two swiveling members 40 to swivel in opposite directions.

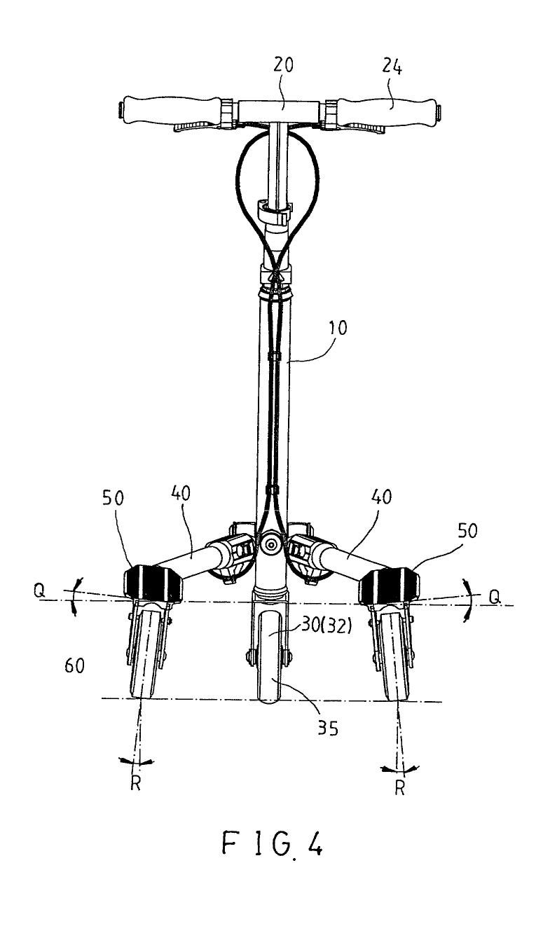

As shown in FIG. 4, a person rides the tricycle 1 of the present invention in such a manner that both feet 8 of the person are rested on the tread surfaces 53 of the two footboards 50. In light of the angle Q of the tread surfaces 53, the soles of the person riding the tricycle 1 are capable of cooperating with the tread surfaces 53, thereby minimizing the likelihood that the ankles of the rider are injured.

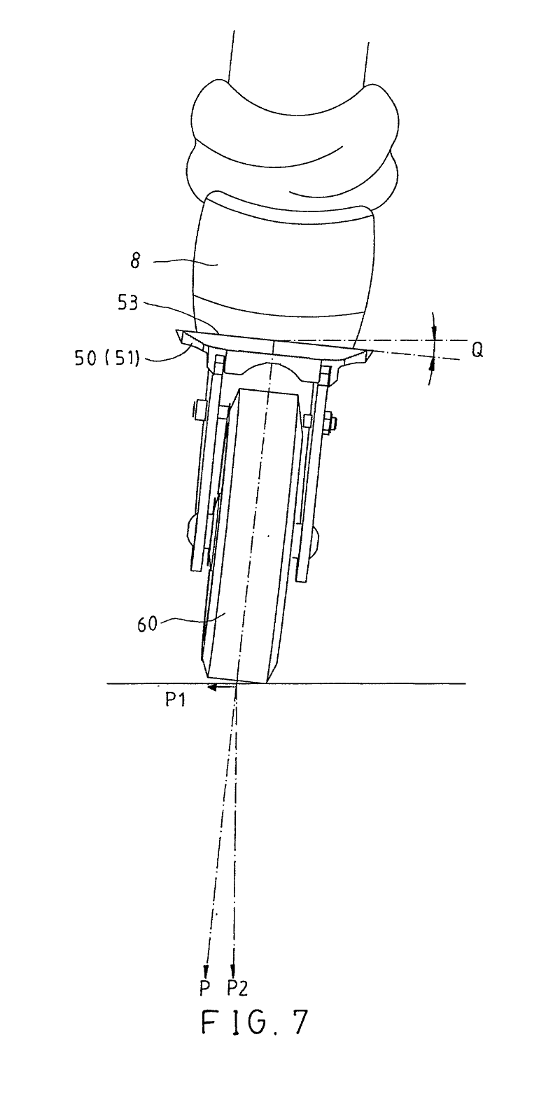

As illustrated in FIG. 7, the footboards 50 of the tricycle 1 of the present invention are relatively stable. The force P of the rider's left foot 8 is transmitted to the ground surface via the rear wheel 60 and is composed of a horizontal component force P1 and a vertical component force P2 in relation to the angle Q. The horizontal component force PI provides the swiveling members 40 with an outward force capable of stabilizing the footboards 50.

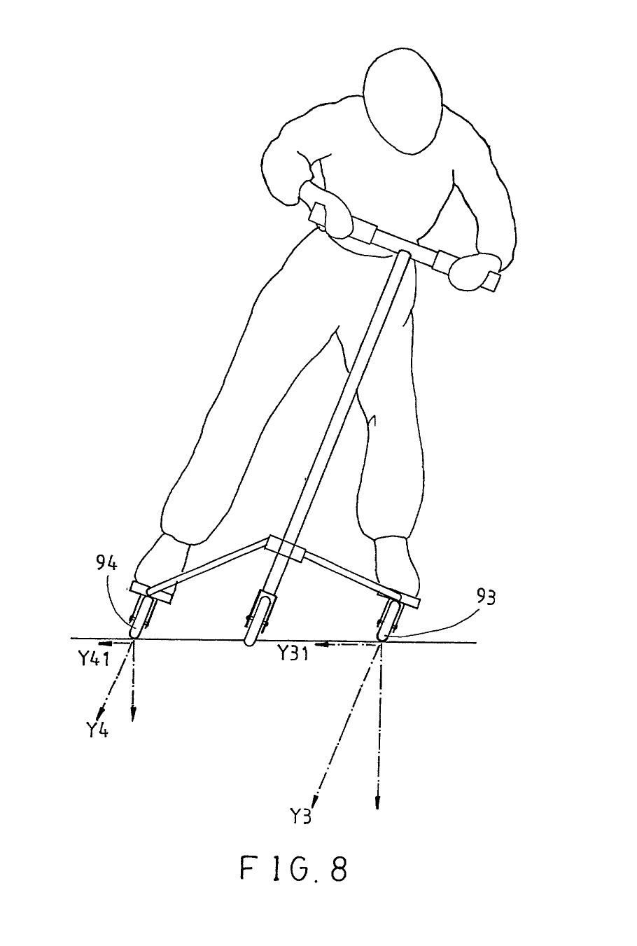

As shown in FIG. 8, a person rides the tricycle 1 of the present invention in such a way that both hands of the person hold the grip portions 24, and that both feet of the person are rested on the footboards 50. The tricycle 1 is moved forward by rotating repeatedly the handlebar set 20 and by tilting the tricycle 1 leftward and rightward in a reciprocating pattern. When the tricycle 1 is cruising or negotiating a curve, the center of gravity is located on the left footboard 50. Accordingly, the force F₁ is greater than the force F₂. The horizontal component force F₁₁ brought about by the force F₁ of the present invention is smaller than the horizontal component force Y₃₁ of the prior art. As a result, the present invention brings about a relatively smaller friction force and a relatively smaller centrifugal force in relation to the ground surface. The tricycle 1 of the present invention is relatively safe. The horizontal component force F₂₁ of the force F₂ of the right rear wheel 60 of the tricycle 1 of the present invention is greater than the horizontal component force Y₄₁ of the prior art. As a result, the right rear wheel 60 of the present invention has a relatively better acceleration effect.

The footboards of the present invention may be mounted on the swiveling members in such a manner that the footboards are detachable, and adjustable in accordance with the requirements of an individual rider.

What is claimed is:

1. A tricycle comprising:
a front tube;
a handlebar set pivotally fastened with said front tube;
a front fork pivoted with said handlebar set;
a front wheel pivoted with said front fork;
two swiveling members pivoted with said front tube;
two footboards mounted on said swiveling members and provided with an inclined tread surface; and
two rear wheels pivoted to said footboards.

2. The tricycle as defined in claim 1, wherein said inclined tread surface has an inclination ranging between 1 and 10 degrees.

3. The tricycle as defined in claim 1, wherein said rear wheels have a center line perpendicular to said tread surface of one of said two footboards corresponding to one of said rear wheels.

4. The tricycle as defined in claim 1, wherein said footboards are detachably mounted on said swiveling members.

5. The tricycle as defined in claim 4, wherein said footboards are adjustably mounted on said swiveling members.
